(19) United States
(12) Patent Application Publication
(10) Pub. No.: US 2005/0121867 A1
(43) Pub. Date: Jun. 9, 2005

(54) Motorcycle stand

(76) Inventor: Ray Brien, Thornton, CO (US)

Correspondence Address: LATHROP & GAGE LC, 4845 PEARL EAST CIRCLE, SUITE 300, BOULDER, CO, 80301, US

(21) Appl. No.: 11/007,847

(22) Filed: Dec. 9, 2004

Related U.S. Application Data
(60) Provisional application No. 60/528,080, filed on Dec. 9, 2003.

(51) Int. Cl. B62B 1/00

(52) U.S. Cl. 280/47.24

(57) ABSTRACT

A motorcycle stand lifts and supports a motorcycle or other wheeled vehicle, and is suitable for uses such as training, display, detailing, maintenance, testing, and sales demonstrations. The stand has a base, two axle support members each including a support fixture, one or more handles, and two or more wheels coupled with the base. Lifting the handles and rolling the stand on the wheels enables positioning of the support fixtures underneath a motorcycle's rear axle. Lowering the handles until the base is flush with the ground raises the support fixtures and the motorcycle's rear axle, such that the rear wheel of the motorcycle is off the ground and rotatable between the axle support members.

### RELATED APPLICATIONS

This application claims priority to U.S. Provisional Patent Application No. 60/528,080, filed on Dec. 9, 2003 and entitled MOTORCYCLE STAND; the above-referenced application is incorporated herein by reference.

### BACKGROUND

Motorcycling is a popular hobby for both men and women. It is nonetheless difficult to train an individual on a motorcycle, particularly when the motorcycle is heavy in comparison to the individual. It is also difficult to disassemble or adjust the motorcycle because of its size and weight. For example, since the motorcycle typically parks on a kick-stand, a significant portion of the motorcycle's weight is on the kick-stand, making it difficult to work on mechanical components of the motorcycle. A motorcycle's drive mechanism also cannot be operated for testing or demonstration while the motorcycle is parked on a kick-stand.

### SUMMARY

A motorcycle stand includes a base, one or more handles attached to the base, at least two axle support members mounted to the base, support fixtures, and wheels, such that when the base is lowered, a motorcycle may be levered off the ground and supported by the support fixtures. The axle support members may be adjustably mounted on the base to enable a single stand to adapt to motorcycles of varying sizes, or to other vehicles. The support fixtures may be notches in the axle support members. The support fixtures may be adjustably mounted on their axle support members to adapt to motorcycles of varying sizes, or to other vehicles. A locking mechanism may be included.

### BRIEF DESCRIPTION OF DRAWINGS

FIG. 1 shows a side view of one motorcycle stand.

FIG. 2 shows a top view of the motorcycle stand of FIG. 1.

FIG. 3 shows a front view of the motorcycle stand of FIG. 1.

FIG. 4 shows the motorcycle stand of FIG. 1 with a motorcycle.

### DETAILED DESCRIPTION OF DRAWINGS

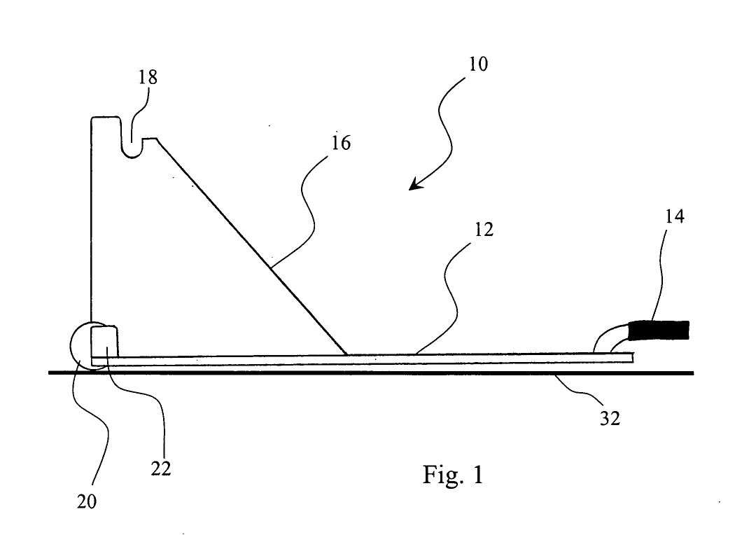

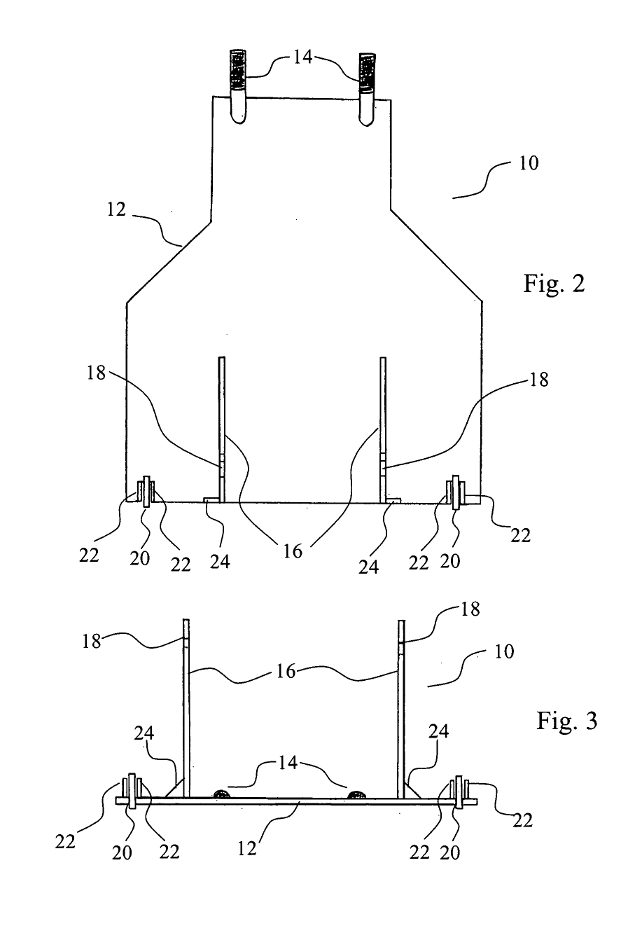

FIG. 1, FIG. 2, and FIG. 3 show a side view, a top view, and a front view respectively, of one motorcycle stand 10. Motorcycle stand 10 includes a base 12, two handles 14, two wheels 20, four wheel support members 22, and two axle support members 16. Each axle support member 16 includes a support fixture 18, as shown. Two gussets 24 provide lateral support to axle support members 16, if desired.

Stand 10 includes two axles (not shown). Each of the axles connects through one of wheels 20 such that this wheel 20 can rotate about its axle, and such that stand 10 is pivotable, on ground 32, about the pair of wheels 20. Handles 14 may be textured or covered with suitable material to enhance the ability of a person to grip the handles with his or her hands.

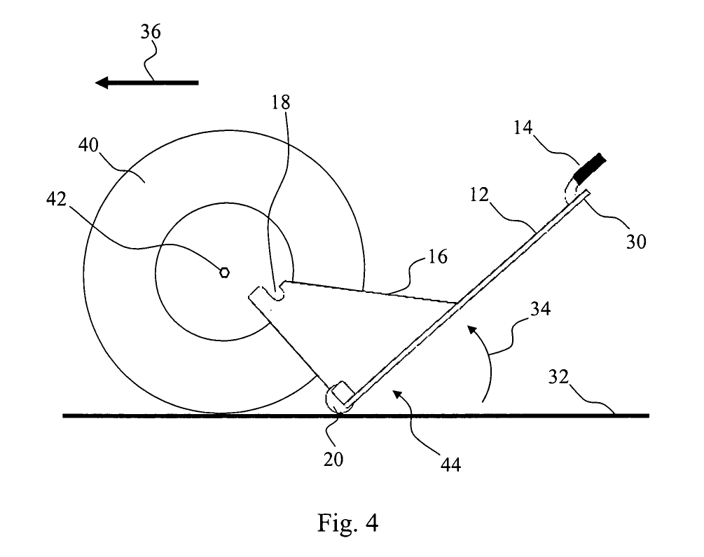

FIG. 4 shows the motorcycle stand of FIG. 1 with a motorcycle rear wheel 40 and axle nut 42. In exemplary operation, a person lifts rear end 30 of base 12 off of ground 32, by grasping and lifting handles 14, so that base 12 pivots about wheels 20 (in a “pivot” state) on ground 32 and in the direction shown by arc 34. With stand 10 in the pivot state of FIG. 4, the person rolls stand 10, along direction 36, to a motorcycle rear wheel 40. The person then lifts handles 14, pivoting axle support members 16 forward (and lowering fixtures 18), and positions support fixtures 18 under appropriate support members (e.g., axle nuts 42) of the motorcycle, and on each side of motorcycle rear wheel 40. The person then lowers handles 14 in the reverse direction of arc 34, rolling the front end 44 of stand 10 forward (in direction 36), to lift rear wheel 40 off of ground 32. Stand 10 is in a “resting” state when base 12 is flush with ground 32.

Stand 10 thus acts as a lever (i.e., moment arm) to raise motorcycle rear wheel 40, such that a large movement of handles 14 lifts motorcycle wheel 40 by a lesser amount (to provide lifting leverage). With base 12 fully lowered to ground 32 (i.e., in the resting state), support notches 18 hold the weight of the motorcycle between wheels 20 and handles 14 such that this weight holds base 10 down, for stability.

To dismount a motorcycle from stand 10, the above procedure is reversed. With reference to FIG. 4, a person lifts handles 14 in the direction of arc 34 until the motorcycle's rear wheel 40 rests on ground 32, and until axle support members 16 are pivoted far enough forward to permit them to pass freely beneath support members (e.g., axle nuts 42) of the motorcycle, on each side of motorcycle rear wheel 40. Stand 10 is then rolled backwards, in reverse to direction 36, until clear of the motorcycle.

The motorcycle stand as described herein is thus suitable for uses such as training, display, detailing, maintenance, testing, and sales demonstrations.

Other embodiments are readily apparent without departing from the scope hereof. For instance, the dimensions of motorcycle stand 10 can be adapted to support motorcycles of varying dimensions, or to support other two wheeled vehicles. One or more of axle support members 16 may mount to base 10 with tracks or other mechanisms to allow adjustment of a stand 10 for vehicle wheels of different widths. Support fixtures 18 may mount to axle support members 16 with tracks or other mechanism to allow adjustment to accommodate vehicles of different heights. Support fixtures 18 may be other fixtures (i.e., other than “notches”) to support other parts of a vehicle; accordingly, the supported parts of a vehicle may be other than axle nuts. Multiple axle support members 16 may be added to support vehicles with three wheels or more. There may be more or fewer handles 14, as a matter of design choice. Base 12 of stand 10 need not be flat, but may be any shape compatible with the use and removal method described above. Hardware may be added to stand 10 to affix a motorcycle or vehicle thereto (e.g., a locking mechanism may be added).

The changes described above, and others, may be made in the motorcycle stand described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A stand for a motorcycle, comprising a base;
two axle support members rigidly extending from the base, each of the axle support members including a support fixture;
one or more handles connected with the base;
two or more wheels coupled with the base; and
wherein lifting the handles lowers the support fixtures such that the stand is positionable underneath a motorcycle's rear axle, and wherein lowering the handles raises (a) the support fixtures and (b) the motorcycle's rear axle, when the motorcycle's rear axle is aligned with the support fixtures, to lift a rear wheel of the motorcycle off the ground to be rotatable between the axle support members.

2. The stand of claim 1, wherein the support fixtures are notches in the axle support members.

3. The stand of claim 1, wherein one or more of the axle support members are adjustably mounted on the base.

4. The stand of claim 1, wherein one or more of the support fixtures are adjustably mounted on one or more axle support members.

5. The stand of claim 1, further comprising a locking mechanism.

6. A motorcycle stand, comprising:
a base;
one or more handles fixed to the base;
two or more axle support members fixed to the base, each of the support members having a support fixture to attach to structure on one side of a rear wheel of a motorcycle;
the stand being in a pivot state when the handles are lifted, such that the support fixtures are positionable underneath the structure, the stand being in a resting state when the handles are lowered and the rear wheel is suspended upon the support members.

7. The stand of claim 6, further comprising one or more wheels rotatably mounted to the stand, to facilitate positioning of the stand in the pivot state.

8. A method for raising a rear end of a motorcycle, comprising:
lifting handles attached to a base, to lower support fixtures of axle support members extending from the base;
while lifting the handles, rolling the base such that the axle support members align underneath a rear axle of the motorcycle; and
lowering the handles to rest the base on ground, such that a rear wheel of the motorcycle lifts off of the ground and can rotate between the axle support members.

9. The method of claim 8, wherein the support fixtures are notches in the axle support members.

10. The method of claim 8, comprising the additional step of adjusting one or more of the axle support members to adjust for the width of the motorcycle.

11. The method of claim 8, comprising the additional step of adjusting one or more of the support fixtures to adjust for the height of the motorcycle.

12. The method of claim 8, comprising the additional step of locking the motorcycle to one or more of the axle support members.
